(19) United States
(12) Patent Application Publication
(10) Pub. No.: US 2010/0054481 A1
(43) Pub. Date: Mar. 4, 2010

(54) Scalable Distributed Data Structure with Recoverable Encryption

(76) Inventors: Sushil Jajodia, Oakton, VA (US); Witold Litwin, Thiers/Theve (FR); Thomas Schwarz, San Jose, CA (US)

Correspondence Address: GEORGE MASON UNIVERSITY;OFFICE OF TECHNOLOGY TRANSFER, MSN 5G5, 4400 UNIVERSITY DRIVE, FAIRFAX, VA, 22030, US

(21) Appl. No.: 12/548,975

(22) Filed: Aug. 27, 2009

Related U.S. Application Data
(60) Provisional application No. 61/092,151, filed on Aug. 27, 2008.

(51) Int. Cl. H04L 9/08; G06F 12/08

(52) U.S. Cl. 380/284; 711/118; 380/283; 711/E12.017

(57) ABSTRACT

Embodiments of the present invention store application data and associated encryption key(s) on at least k+1 remote servers using LH* addressing. At least k+1 buckets are created on separate remote servers. At least k+1 key shares are generated for each of at least one encryption key. Each encryption key has a unique key number. Each key share is stored in a different key share record. Each of the key share records is stored in a different bucket using LH* addressing. Encrypted application data is generated by encrypting the application data with the encryption key(s). The encrypted application data is stored in encrypted data record(s). Each of the encrypted data records is stored in a different bucket among the buckets using LH* addressing.

### CROSS-REFERENCE TO RELATED APPLICATIONS

This application claims the benefit of U.S. Provisional Application No. 61/092,151, filed Aug. 27, 2008, entitled “A Scalable Distributed Data Structure with Recoverable Encryption,” which is hereby incorporated by reference in its entirety.

### BACKGROUND

More and more applications can benefit from scalable distributed data structures (SDDSs) for their storage needs. An SDDS stores data on a number of servers, which gracefully adjusts to the data size. Example applications where scalability became a buzzword, include, but are not limited to, data management in companies, health systems, personal data servers, remote backup, web services like Simple Storage of Amazon.com, archive systems and P2P social networks. Many of these applications have strict confidentiality needs. However, the servers of an SDDS might not be under the administrative control of the owner of the data or would need to be administered more securely. For example, an administrator (or the “owner” of a root-kited system) can dump and analyze all local data. Client-side secret key encryption provides an efficient tool for protecting the confidentiality of data stored in a possibly hostile environment. However, key management is a well known drawback to using this technology. Loss and leakage of keys are often a prelude to a disaster. Furthermore, records and hence their keys might be long lived, adding to the key management challenge. One current solution is to release keys to some third party escrow system that safeguards the keys and provides key recovery upon request. This idea has not been popularly adopted and is currently not easy to use. Another approach uses secret sharing on the records instead of encrypting them, such as in the Potshards scheme, (described in “POTSHARDS: Secure Long Term Storage Without Encryption” by Storer et al. at the 2007 Annual USENIX Association Technical Conference). Potshards is explicitly designed for long-term archival storage that needs to survive several generations of secret key schemes (e.g. AES replacing DES) without re-encryption. Its drawback is the large storage overhead, which is not acceptable for data that is currently in use and located in storage that is more expensive. In the very last sentence of a generic article on the subject, Wikipedia conjectures, in the wake of a research proposal, that a way out is perhaps a key based encryption of large data objects, with the secret sharing limited to the safety of the key storage. Keys are usually much smaller than records; the storage overhead of secret sharing should greatly decrease accordingly. Current industrial practices advocate encryption by the data host, and not the data owner, unless “data security is paramount.” It is questionable how users feel about the resulting lack of control.

What is needed is a new tool for storing data records that is scalable, allows a user to define their encryption and relieves a user from the task of managing keys.

### BRIEF DESCRIPTION OF THE SEVERAL VIEWS OF THE DRAWINGS

FIG. 1 is a system block diagram showing multiple LH*_{RE} clients and k+1 servers connected through a network as per an aspect of an embodiment of the present invention.

FIG. 2 is a system block diagram showing an example client interacting with k+1 servers as per an aspect of an embodiment of the present invention.

FIG. 3 is a block diagram of an example LH*_{RE} client as per an aspect of an embodiment of the present invention.

FIG. 4A is a block diagram of an example encrypted data record as per an aspect of an embodiment of the present invention.

FIG. 4B is a block diagram of an example key share record as per an aspect of an embodiment of the present invention.

FIG. 5 is a flow diagram of an example method for storing application data and encryption key(s) on k+1 servers using LH* addressing as per an aspect of an embodiment of the present invention.

FIG. 6 is a flow diagram of an example method for recreating a key associated with a user identifier and a specific key number from key share records retrieved from multiple servers using LH* addressing as per an aspect of an embodiment of the present invention.

FIG. 7 is a flow diagram of an example method for recreating all keys associated with a user identifier from multiple servers using LH* addressing as per an aspect of an embodiment of the present invention.

### DETAILED DESCRIPTION OF EMBODIMENTS

Embodiments of the present invention, (periodically described in this disclosure as LH*_{RE}) are a new tool for storing data records that is scalable, allows the users to define their encryption, using one or many keys per user, and relieves them from the task of managing keys.

LH*_{RE}, as an LH* scheme is scalable. (For an explanation of LH*, see: Litwin, W, Neimat, M-A., Schneider, D. LH*: A Scalable Distributed Data Structure. ACM-TODS, (December 1996); Litwin, W. Moussa R, Schwarz T. LH*_{RS}—A Highly Available Scalable Distributed Data Structure. ACM-TODS, September 2005; and Litwin, W. Yakoubin, H., Schwarz, Th. LH*_{RS}^{P2P}: A Scalable Distributed Data Structure for P2P Environment. NOTERE-08, Jun. 2008). In LH*_{RE}, the user defines encryption, but is relieved from the task of managing keys. LH*_{RE} protects keys by secret sharing. Users can choose from a spectrum defined by the extremes of using a single key per record or one key for all records. Finally, an authorized (trusted) LH*_{RE} client can recover any encryption key and therefore encrypted record, regardless of collaboration by the owner (encrypting party). This allows an authorized party to access the records of an unavailable client or a client to recover its own keys.

LH*_{RE} creates (k+1) shares of keys for each client key. One embodiment may use the now classic XOR-based scheme described by Shamir. (See Adi Shamir: How to share a secret. Communications of the ACM, vol. 22(11), 1979). LH*_{RE} provides each share with a dedicated primary key and stores the shares using the LH* addressing scheme accordingly. The scheme guarantees that the shares are always on (k+1) different nodes. While records migrate in any SDDS, these migrations will never result in shares being located on the same server. While the majority of the SDDS accesses are direct, the scheme also prevents that different shares of a key end up transiting through the same the same server.

As a result, an attacker of a server bent on reading a record needs to successfully penetrate (k+1) servers, unless the attacker could access the record and break the encryption. With current well-know encryption schemes the latter avenue is impossible at present. There is an assumption that one can trust the client node, in particular that it is immune against the message sniffing. Only a massive series of break-ins should leak confidential data. LH*_{RE} records do not give indications where the key shares are stored so that the attacker has to break into the vast majority of storage servers.

In the basic LH*_{RE} scheme, the storage overhead incurred is small, whenever, as usual, keys are small relative to records. The basic scheme provides a new encryption key for every record. Its message count costs associated with record insertion, update delete or search are about (k+2) times those of LH*. A variant has been analyzed that lowers the message counts of a search and of an update to those of LH*. The variant uses an additional share, termed private. The client caches this one locally and uses it for the private encoding of the encryption key, stored with the record. An additional benefit is the secret-sharing for the encrypted record itself. If the record was, e.g., a testament, one could decrypt it only by all the heirs together.

An LH*_{RE} embodiment is disclosed that lowers the message counts of all manipulations of records such as key-based searches, inserts, updates and deletes. The messaging cost is that of LH* and thus optimal in the sense of absence of encryption related message count overhead. The variant uses predefined keys. The client uses secret sharing for each key. It also caches all keys in local storage (e.g. in RAM). Unlike in the basic scheme, the same key can encrypt several records. The user has flexibility of choosing between encryption of individual records with about individual keys or using the same key for many, if not all records. This choice is one of balancing assurance and disclosure. The former measures the expectation that an intrusion of l servers does not disclose data. The letter measures the amount of data disclosed in a successful intrusion. The key space can be scalable, providing, in particular for the desired ratio of records per encryption key used, hence for the desired disclosure amount. The secret size can scale as well. This may help to prevent the assurance deterioration in a scaling file.

A file structure and its manipulation are discussed below, including the algorithms for the key recovery and revocation. Also discussed are performance factors and file design criteria.

File Manipulation:

File Structure

An LH* file stores data structured into records with primary keys and non-key fields. Records in an LH*_{RE} file are application data records and key shares. Records may be stored in buckets numbered 0, 1, 2 . . . . Each bucket is located at a different server (node). Initially, a typical LH* file is created with bucket 0 only, but then grows to more buckets through bucket splits. In contrast, an LH*_{RE} file is created with at least k+1 buckets, i.e. buckets 0, 1, . . . , k, k+1. In other variants, k could be zero or started with k+2 initial nodes to avoid collocating a record with any key share. Starting with more initial buckets enhances the inability of an attacker to find shares of a given key. An LH* file (including an LH*_{RE} file) spreads over more buckets through a series of bucket splits. In each bucket split, about half of the splitting bucket's records move to a new bucket. All applications access records through an LH*_{RE} client node. Each client has a unique identifier (ID). Typically, several clients share a file. The client does not store any application data. It's generic LH* role is to manage the dialog with the servers. It's LH*_{RE} specific role is the encryption of data on behalf of an application and the encoding of the encryption keys. Details are provided below. The client is also responsible for sending out queries and the records to store. Record search, insert, update, and delete queries are key-based. A dynamic hash function h may be used that calculates the record location given a certain number of buckets over which the database is spread.

LH* splits are not posted synchronously to the clients. A client may be therefore unaware of the actual file extent. The address calculation may send in consequence a query to an incorrect (outdated) location. Recall that LH* locates nevertheless any record with at most two additional hops. Also, the great majority of requests reach the correct buckets directly. Moreover, if all nodes are peers (combine the role of server and client) then at most one additional hop suffices. LH* addressing is indeed faster in this sense than that of any other known SDDS and DHT-based schemes. If there are hops, the LH* client gets from the servers an Image Adjustment (IAM) message. IAMs prevent a client from committing the same addressing error twice.

Encryption Key Caching and Encoding

The client has the encryption key cache with the capacity to store N≧1 keys. The client may uses the cached keys, and only these keys, in this variant, to encrypt data records. N may be user or administrator defined. N can be static, or may scale as sketched below. The encryption may be symmetric, e.g., AES. The client generates the keys. They could be also application defined. The client may generate key values at random, (e.g., using white noise) or using other (preferably proven) method. The cache itself may be a one-dimensional table T [0 . . . N−1]. The client inserts the N keys to the cells in any desired way.

The client may cache and encode encryption key(s) prior to use. The encoding uses the secret-sharing into k+1 shares, k=1, 2 . . . . The choice of k may differ among the clients. It reflects a client's assurance that the disclosure of any data by intrusion into any (k+1) nodes is very unlikely. Different users may have different estimates of the assurance. Regardless of the approach, higher k usually increases assurance.

In addition to the keys, the client generates (k+1) random and different values C₁ . . . Cₖ₊₁. These values are the primary keys of share records, i.e. the records that contain a share of a key. Given the LH* generic principles, each Cᵢ should be unique, i.e., different from any data record key or share key. The C₁ . . . . Cₖ₊₁ are chosen to be placed in different buckets. The client may test each generated share record key for a collision and resolve this by generating a new key. The client formats the k shares into records Sᵢ=(Cᵢ, T, I, Nᵢ). Here, T denotes the offset of the encoded key in T. The T-field may be needed for key recovery, as discussed below. Next, I denotes some identity of the client, or more generally, any information provable upon request that the future requester of the record is entitled to access it. The choice of I value and the authentication method are not parts of the LH*_{RE} scheme, e.g., any well-known approach will do. Finally, each Nᵢ is a different white noise, generated by the client. The client forms also share S_{K+1} as (Cᵢ, T, I, E″) with E″=N₁⊕ . . . Nₖ⊕E, where (⊕) denotes XOR. Finally, the client sends out each Si. Since this embodiment uses linear hashing, the client calculates h(Cᵢ) based on its current image and sends it to the resulting bucket.

Share record generation, encoding, and storing should be a single atomic transaction. Otherwise, a client might use a key that is not maintained and hence unrecoverable.

Data Record Insertion

To insert a data record R with primary key C, the client starts with the encryption of the non-key field of R. For this purpose, for N>1, the client applies some hash function h_{T} mapping every record key C into [0, N−1]. For instance, one can set for h_{T} (C)=C mod N with possibly N being chosen to be a power of 2. Values of N may vary among the clients, but h_{T} has to be the same for all clients in order to enable key recovery, as we will see below. The encryption is symmetric using the key cached in T[T] with T=h_{T} (C). Afterwards, the client adds the non-key field I to an encrypted R with its identification. It also stores N in as the non-key field. The fields serve the key recovery as it will appear. Finally it sends out the record to server h(C), as usual for an LH* file.

Record Search

To search record R with given key C, the client sends the query to bucket h(C). Provided the search is successful, the client retrieves key E cached in T[h_{T}(C)]. The client decrypts R using E and delivers R to the application.

The LH* record search through a scan, exploring the non-key data of every stored data record, obviously does not make sense for LH*RE. The LH* scan operation remains in use only for the key recovery and revocation, as discussed later on.

Record Update and Delete

The LH*_{RE} record update involves a search with decryption, unless the update is blind, and reencryption, being otherwise carried as for LH*. The deletion is carried as for LH*.

Key Recovery

(Encryption) key recovery reconstructs one or more encryption keys from the shares, without a priori knowledge of share (primary) keys. Encryptor I may perform key recovery if for any reasons it lost a part of its T, perhaps because of memory corruption or hardware failure. Another need can be to decrypt a specific data record, identified by its primary key C, by an authorized client I′ other than I. In addition, a given client I may become unavailable—and with it T, while another authorized client I′ needs to continue to use the data, e.g., in a company or an archival system. The servers should trust or should be able to verify I received. This verification is not a part of our scheme, any well-known technique will do. Otherwise, a specific client of LH*_{RE} called an Authority, identified as client A, with A trusted by every server, may also start the key recovery, handing it over to I′ for termination. The recovery process performs the LH* scan operation.

We recall that LH* scan sends a query Q to all the currently existing buckets, using multicasting or unicasting. The latter may be handled in many ways; each assuring that all file servers get Q and only once, while some servers are perhaps unknown to the client. The scan termination handling the reply unicast messages can be probabilistic or deterministic. Only the latter is of interest here. A deterministic protocol guarantees that the client gets all replies it should. Specifically, to recover given encryption key E, lost in cell T in T, I or A issues scan Q with semi-deterministic termination requesting every share with I and T, to be sent back to the requester or perhaps to I′ on behalf of A. The server receiving Q verifies the identity of the requester. Q brings the matching shares back to I or A, or to I′. The termination protocol counts the messages until (k+1). If the count is not reached after some timeout, the client considers some server(s) unavailable. It resends the scan using the (fully) deterministic LH* termination protocol. This protocol will localize the server(s) to recover. Currently, high or scalable high availability is not designed for LH*_{RE}, but it is already implemented in many different variants for LH* at large. The receiver recalculates E and finishes the recovery, by an update to T [T].

Similarly, to recover the key encrypting some record R with given primary key C, the requester reads T in R, after perhaps a search of R not yet at the client, continuing with scan Q as above. The original client knows N, any other requester uses N value saved in R during the encryption. Finally, to recover all the keys of I, I or A sends out the following scan Q′ with semi deterministic termination. Q′ requests for the sender or for I′, every share with I and T≦N′, with N′ such that the flow received does not saturate the client. The successful scan termination occurs if the client receives (k+1) N messages. It may happen that N≧N in which case Q′ is the only scan. Otherwise the client continues with the further scans needed, after looping on key recovery for each T received. It progressively fills up T. The final dimension of T recovers N, hence it recovers h_{T} as well.

Key Revocation

Key revocation means here that for some good reason, the encryptor should no longer decrypt selected data records. Two cases that appear practical are (i) data record R of client I should no more be decryptable through its current encryption key E, and (ii) all the records of client I should no more be decryptable using the current keys. In both cases, the revocation should include the re-encryption of records with a new temporary or permanent key(s). In a company, a specific data record might suddenly need to become unreadable for employee I. Or, employee I was just fired. Or, the laptop with client node I got stolen . . . . In LH*_{RE} file, key revocation basically consists of (a) key recovery by A or of the new client I′ on behalf of A, (b) temporary or permanent re-encryption of R using T of A or I′. Notice that case (i) may require A to re-encrypt R with some unique temporary key, to avoid that I′ gains the side-effect capability to decrypt also other records encrypted by I through E. If the revocation concerns all the records of I, one also deletes all the shares of I.

Cache Scalability

As mentioned, insertions may optionally trigger the cache scalability. Basic benefit is the generation of a small cache with a few keys only for a small file, scaling progressively with the file growth. The process may be further designed so that the client may specify the desired average number r of records per encryption key in the file. Cache scalability lay automatically maintains r, while expanding the cache. The actual number of records per key varies of course, being, e.g., under r initially, but should remains close to r. The feature seems of interest. Unlike a static cache, it keeps the balance between the assurance and disclosure size.

Cache scalability providing this function works for variant as follows. Given the average load factor of an LH* file that is about 0.7, the current cache size N for the file of M buckets (servers) with the capacity of b data records per bucket, should be about N=0.7 bM/r. To start working, assuming that the file has M=(k+1) servers initially, the client sets initial N accordingly and generates N encryption keys. It also uses N for any coming record manipulation. With new inserts, at one point an IAM comes. The client learns that the file has no more M buckets, as in the client image, but, at least, M′>M buckets. The client adjusts the image as in general for LH* scheme. In addition, it scales the cache to N′=0.7 bM′/r cells. Actually, it adds N′−N cells to T and appends as many new keys. It finally assigns N to the current, i.e., performs N:=N′. From now on, i.e., till next IAM, the client uses either the current of N for any encryption of a new record, or the N value found in the record for the decryption. The re-encryption in the case of an update may apply either one.

Notice that the above scheme considers a single process at the client. If there concurrent threads, as usual under current software architectures, one has to add some concurrency management. Consider for instance two IAMs processed concurrently.

Secret Scalability

An insert may also trigger optionally the secret scalability. The required secret size, i.e., k value, scales then as well, as mentioned. The number of shares per each encoded key increases accordingly, enhancing the assurance. The investment may be wise for a scaling file. It is easy to see that as the number of file servers grows, the probability of k-node intrusion at least may grow as well, for any fixed k. Assuming, for instance, some fixed probability of a node intrusion and independence among the servers as, e.g., typically on a P2P system.

To enable the secret scalability for a client, the client should be the exclusive one, or the client collections of records and encryption keys are all distinct. The client sets up some values of M as successive thresholds for increasing k by one. For instance, the client may be poised to increase k by one any time the file doubles. The successive thresholds are then defined as Mᵢ₊₁=2Mᵢ; with i=0, 1, 2 . . . and M₀ denoting the initial file size, M₀≧(k+1) as we spoke about. The client proceeds then as follows. It waits for an IAM informing that actual M reached or exceeded current Mᵢ. It issues then the LH* scan query requesting shares with T=0, 1 . . . L−1, where L is the scan performance related increment, as N′ used for the client keys recovery above. For each T value, the client retains one of the shares received; let us denote it as ST. The client creates also a new noise Nₖ₊₁, stores it as a new share Sₖ₊₁ and updates share ST in the file to ST:=ST⊕Nₖ₊₁. From now on, the secret for each key is shared by (k+1) shares. Once done with the current scan, the client requests next scan, for next N elements of T, till it explores whole T.

Notice that the above scheme does not require the entire, possibly quite long obviously, operation to be atomic. The file remains accessible, while the secret size increased for some but yet not all keys. It seems to make sense then to introduce, for the behavioral analysis at least, the concept of the file secret-sharing level defined as the minimal k among all the records. Notice also that at present the concurrency is ignored, this time however both at the client and at the servers. At a glance, at least, the update to share ST and creation of Sk+1 should be made atomic. Otherwise, e.g., a concurrent key recovery could end in error. Obviously, one needs some concurrency management with, e.g., 2PC protocol.

Scheme Analysis:

Assurance and Disclosure

Assurance is here broadly the confidence that an intrusion creating data disclosure will not happen. How to measure the (amount of) disclosure if it happened anyhow is discussed below. Under the current assumptions, the intruder (attacker) has only two ways to proceed. The first one is to use brute force to decrypt the data records. Success mainly depends on the strength of the encryption key. Current schemes such as AES are likely not vulnerable to a successful crypt-attack. If the user chooses to have a key encrypts at most a few records only, the success of the hard work would be quite limited. As one increases the number of records encoded with the same key, the possibility of successful attack increases. Having fewer keys may nevertheless potentially benefit the assurance otherwise, as it will appear below.

Alternatively, an attacker can collect all k+1 shares of an encryption key E for a given record R and also gain access to the bucket with R. Unlike previous variants, R might be collocated with one of the shares. The shares however are always on different servers, as long, as usual, the buckets may only split. This is because shares are initially placed on different servers and LH* splitting has the generic property of never placing two previously separated records in the same bucket (of course the opposite is not true). Likewise, if a record sent by a client gets forwarded by some bucket, a record sent by the client to another bucket cannot get forwarded through the same bucket. A sever cannot thus, even transitively get the knowledge of two shares of a key. Because of these (fundamental in the context) properties, an attacker will always have to break into at least (k+1) servers to access all shares. Notice that if buckets are allowed to merge, in a heavily shrinking LH*_{RE} file, then in contrast two shares could end up collocated. Heavily shrinking files becoming rare.

Even if an attacker is the administrator of a node and thus knows the location of a record or of a share, the attacker does not know the location of the other data needed to access the record. Since an SDDS file has usually at least dozens if not thousands of nodes, guessing the remaining k locations is hopeless. Notwithstanding that the shares move with the splits, with the 50% probability on the average.

All things considered, the disclosure of a specific record in embodiments of LH*_{RE} variants should be very difficult. The intruder (attacker) may however adopt the spider attack strategy. Namely, to break into any specific (k+1) servers, to disclose whatever one could find there. The spider attack may be, for instance, appealing to an insider, in charge of some but not all servers of a “server farm”. The evaluation of the probability of intrusion into such (k+1) nodes is beyond the schema. In contrast, one can evaluate the conditional disclosure that such an intrusion may bring. One way is to estimate probability P of a successful disclosure of a record. This one is also the probability that R′ and its shares are all at the intruded servers. P provides further with another measure that is the expected number M of records that the intruder could disclose. M depends on the choice of k, on N and on bucket capacity. One can consider M value as a rationale for the choice of parameter k. Indeed, k should be the minimal value that achieves the expected disclosure size M, where M should be much smaller than one. Larger values of k would create an unnecessary burden of encoding and decoding. They might however be justified if the client considers breaking into more than k+1 servers feasible. The following example illustrates the point.

Consider an SDDS with 100 server nodes containing 1 M data records, i.e., b=10.000 per server on the average. Let it be k=1 and N=1. A successful attack (intrusion) breaks into any two servers. The probability that the two servers have both shares R′ is P=1/C2 100≈1/5000. Since N=1, the intruder would be able to disclose all the records in these two buckets, i.e., M=20 000 on the average. Choosing k=2, lowers P to about 1/30 000. Likely, k=2 should be the smallest value to choose for k. M remains however the same if the unthinkable occurs. If the same file had fewer servers, e.g., 10 servers only, k≧4 should rather be a decent minimum. Notice that this property also means that disclosure assurance scales well, since it improves with a growing file.

Consider now that N=2. In this case, the (conditional) probability P of key disclosure is about double. However, the disclosure size, in the number of disclosed records, is about half. Some users may consider this a better choice, especially for k=2. Others may apply a larger k that allows them to choose a much larger N for P at least as small. In particular choosing N above (k+1)b reduces the disclosure size to approximately a single record, rivaling previously analyzed LH*_{RE} variants that use a new key for every record.

One may formalize the above analysis, to create a design tool for choosing LH*_{RE} file parameters. Such a tool might measure assurance more formally than in our current analysis, based on the probability that an intrusion does not disclose any data. Another concept implemented in such a tool could be that of conditional disclosure if an attacker intrudes into l servers. One can then estimate the probability of a key disclosure or the expected number of such keys given N and M. Current analysis shows that both assurance and disclosure (variously measured) scale well.

Storage Occupancy and Access Performance

Storage for the encryption keys in the file and in the cache should be negligible. It is O((k+2)N), where the cache accounts for O(N). For AES, e.g., the latter value should be about 32N bytes. With current RAM sizes, this allows for millions of keys. If an LH*_{RE} designer wants the entire cache to fit in the L1 or L2 processor caches in order to achieve high performance, then there is still easily room for thousands of keys. The effective load factor of an LH*_{RE} file, calculated with respect to the data records, should be in practice that of an LH* file with the same buckets and data records. To recall, it should thus be on the average In 2≈0.7.

Messaging cost may be—as usual—the dominant factor in the access times for a record. It is proportional to the message count per operations. The costs for the cryptographic operations are proportional to the size of the data records, but should be negligible. Especially, when symmetric encryption is used.

The same message count costs of both data record insert and searches are those of LH*.

Thus, some of the disclosed embodiments of LH*_{RE} use 1 message per insert and 2 messages per search. In case of an addressing error, this increases by 2 at worst. The update and delete message count cost is as for LH* as well. The combination of the negligible storage overhead with the absence of the encryption related messaging overhead for the data manipulation are advantages of this variant over the two others.

To recall, the basic scheme usually had an insert message count of (k+2) messages and a search cost of 2(k+2) messages. Both costs were thus (k+2) time greater. This does not mean that the response time were proportionally slower since the messages can be processed in parallel. The usual update cost is 2(k+2)+1 messages, hence k+1,5 more. The cost of a blind update (which does not notify the originator of the outcome of the operation) was 2k+3 messages, compared to usually one message. Finally, the usual cost of a normal delete is for both schemes that of a normal update. The cost of a blind delete is that of an insert.

The private share variant has the same search, and update message counts as the current one. Notice that the blind update does not make sense for the private share variant; it is cheaper to process it as the normal one. The insert and blind delete costs are in contrast, the basic one. The current variant remains thus several times faster accordingly. The normal delete operation for the private share variant takes advantage from its fast search. It remains nevertheless several times more costly than the current one.

The message count cost of cached keys creation is usually (k+1)N. A single key recovery given T should usually cost only (k+1) unicast messages replying to Q and one multicast or M unicast messages to send Q out towards all the M buckets of the file. In the unicast based send out case, it is the dominating cost factor. The client part of these M messages can however be as small as a single message. The client sends a key recovery request to bucket 0 that takes care of forwarding the request to all other servers. Key recovery, given a data record should add up usually two messages. The recovery cost of all keys of a client is [N/N′] messages necessary to distribute the scan requests and (k+1)N unicast messages to bring in the shares. Finally, for the key revocation, one should add to the embedded key recovery cost usually two (unicast) messages per record to re-encrypt.

Discussion

The LH*_{RE} scheme with cached keys allows one to insert, search, update and delete data records without any encryption related messaging overhead. It has for these operations the same (messaging) performance as LH* itself. This should make embodiments of LH*_{RE} faster than the basic scheme for all data manipulations. In turn, the scheme needs storage for the cache, possibly RAM or on-chip processor cache, for best speed. This does not seem to be of much practical importance, as current on-chip caches can store thousands of keys and RAM can store millions. Another relative drawback can be a higher amount of disclosure if, and only if, one chooses to use relatively few keys.

Notice also that disclosed embodiments presented here encourages higher values of k. A higher value increases indeed the assurance of the scheme at all times. In contrast, it only negatively matters possibly infrequently, when we recover or revoke a key. Unlike for any the data record manipulation under the basic scheme and inserts and deletes under the private-share variant.

### Additional Embodiments

LH*_{RE} is a Scalable Distributed Data Structure that stores many records protected through key encryption in a scalable file. As often, key management and in particular preventing the loss of keys is of utmost importance. LH*_{RE} is an LH*-scheme that stores records on behalf of clients on any number of servers addressed through the scalable distributed hashing of record identifiers. An LH*_{RE} client encrypts each record using client chosen secret key cryptography. The client also encodes each key using the secret-sharing. Shares may be stored at servers, different for each share and randomly chosen. The client chooses the secret size, i.e., the number of shares. An attacker of a key has to locate all the secret-sharing servers. The task appears overwhelming for an LH*_{RE} file, typically on many servers. An authorized user may rapidly recover or revoke every key, lost, corrupted or of a missing encryptor. In this way, LH*_{RE} frees users from the well-known daring chores of client-side key maintenance.

LH*_{RE} may use a new encryption key for every record, minimizing the number of disclosed records if the unthinkable happened. The storage overhead of encryption, while different for each variant, should be negligible. The overall cost is the message count per operation of basic LH*, i.e., without any encryption related message count overhead. For some applications, this may be a compelling advantage. The client caches the encryption key space with, at will, a single key for all the records or with a large number, e.g., a million keys. The key space can scale, as well as the secret size.

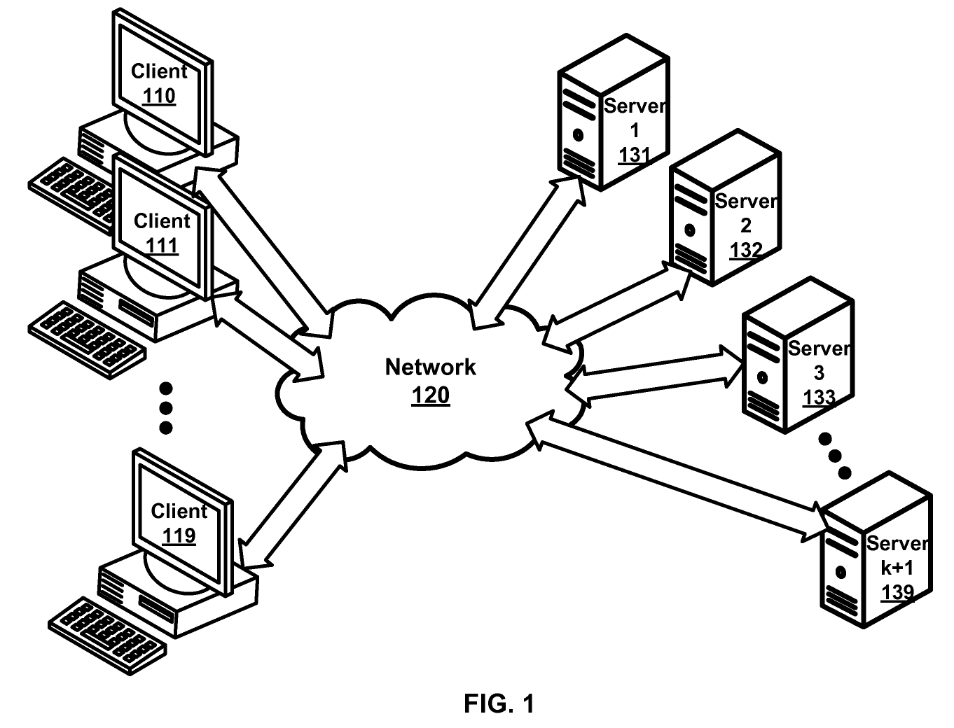

The general inventive concept will become more fully understood from the description given below in combination with FIGS. 1 through 7. Like elements are represented by like reference numerals. These are given by way of illustration only and thus are not limiting of the general inventive concept.

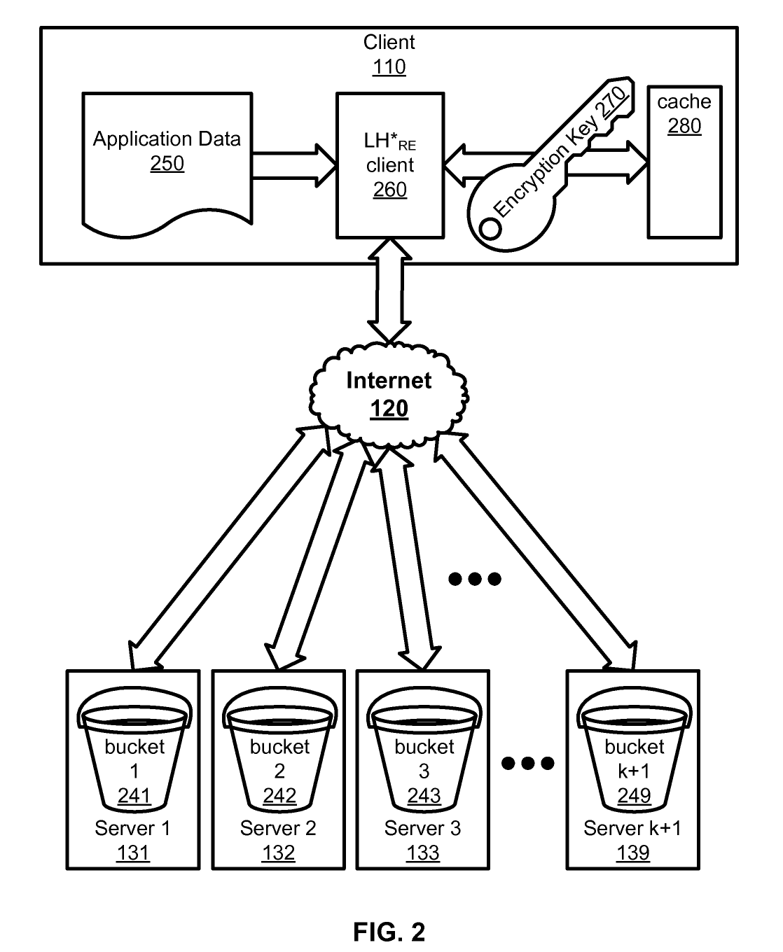

FIG. 1 is a system block diagram showing multiple LH*_{RE} clients (110, 111, . . . 119) and k+1 remote servers (131, 132, 133, . . . 139) connected through a network 120 as per an aspect of an embodiment of the present invention. FIG. 2 is a system block diagram showing an example client 110 interacting with k+1 remote servers (131, 132, 133, . . . 139) as per an aspect of an embodiment of the present invention. In these embodiments, one or more of clients (110, 111, . . . 119) may have an LH*RE client 260 configured to store a version of application data 250 encrypted with an encryption key 270 on remote servers (131, 132, 133, . . . 139).

The remote servers (131, 132, 133, . . . 139) will likely be specialized servers configured to communicate with many client systems (110, 111 . . . 119) and manage data buckets (241, 242, 243, . . . 249). The remote servers (131, 132, 133, . . . 139) may be geographically diverse. Some of the remote servers (131, 132, 133, . . . 139) may also be under control of various organizations. In this way, the stored data may become harder for a third party to locate and retrieve all of the stored application data 250 and key(s) 270.

Embodiments of the LH*_{RE} client 260 may be implemented as a computer readable storage medium that containing a series of instructions that when executed by one or more processors on clients (110, 111, . . . 119), causes the one or more processors to store application data 250 on at least k+1 remote servers (131, 132, 133, . . . 139). In these embodiments, k is a freely set parameter of the system.

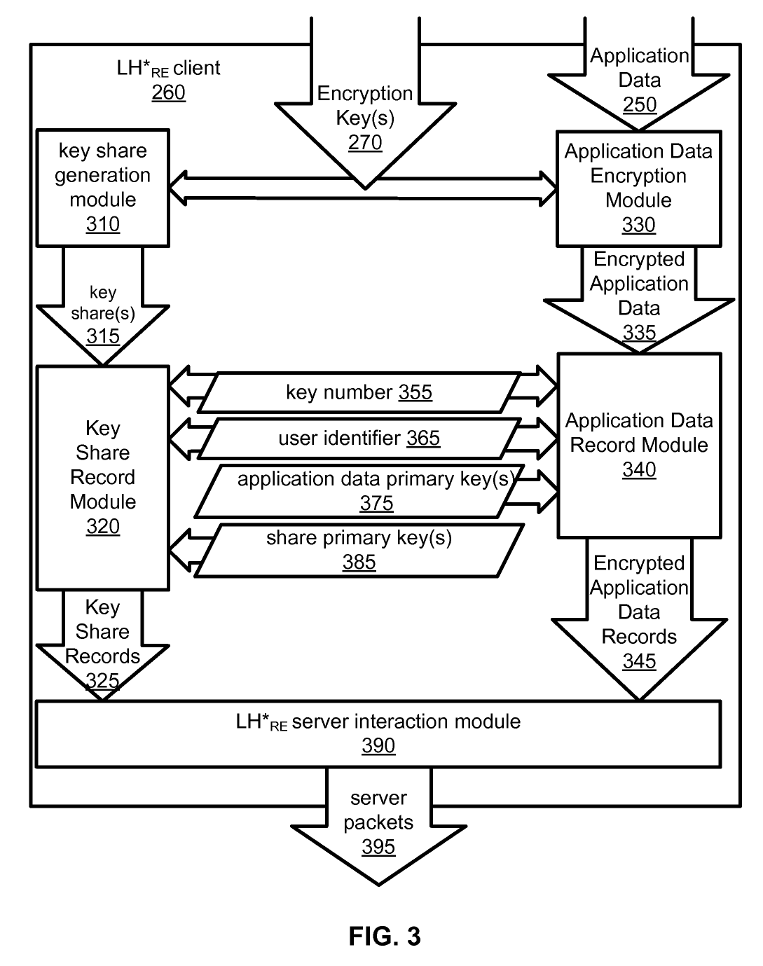

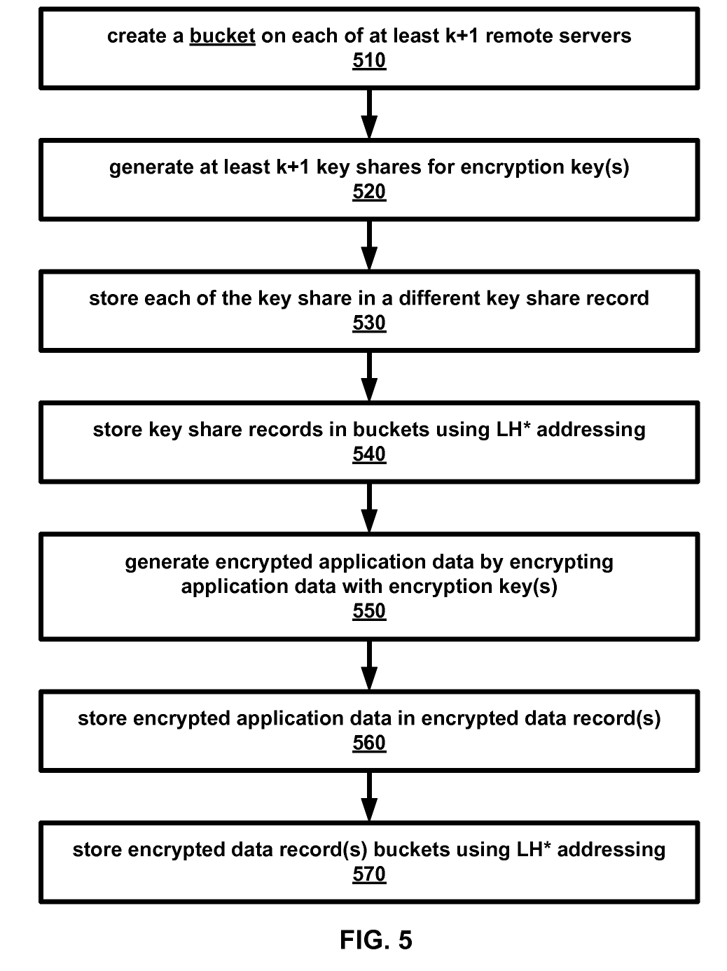

A more detailed description of an example embodiment will be provided with reference to FIGS. 3 and 5. FIG. 3 is a block diagram of an example LH*_{RE} client and FIG. 5 is a flow diagram of an example method for storing application data and encryption key(s) on k+1 servers using LH* addressing.

At 510, at least k+1 buckets (241, 242, 243, . . . 249) may be created. The creation of the buckets is with respect to the LH*_{RE} client. In some cases, the buckets may be created by use of a command to one of the remote servers (131, 132, 133, . . . 139). In other cases, the creation may actually be just the identification of an available bucket on one of the remote servers (131, 132, 133, . . . 139). As described earlier, the creation of the bucket must conform to the constraints of LH* addressing. Specifically, each of the buckets must reside on one of the k+1 (or more) remote servers (131, 132, 133, . . . 139).

At least k+1 key shares 315 may be generated for each of at least one encryption key 270 at 520. Each of the encryption key(s) 270 should have a unique key number 355. Each of the key shares 315 may be stored in a different key share record 325 at 530. The key shares 315 may be generated using any number of know secret sharing techniques including performing an XOR on a multitude of the key shares 315. Other secret sharing techniques, known and unknown may be used.

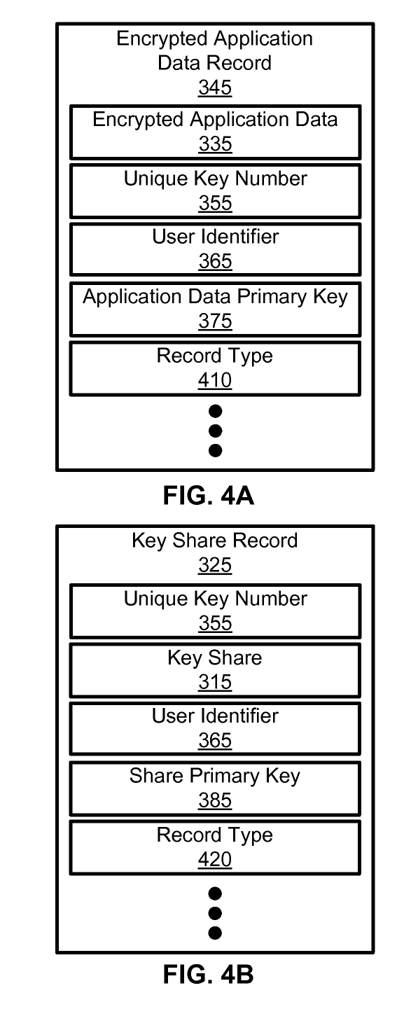

FIG. 4B is a block diagram of an example key share record 325. As shown, each key share record 325 also includes many fields including but not limited to a user identifier 365, a unique key number 355 and a share primary key 385. The unique key number 355 identifies an encryption key 270 that the key share 315 is part of. The user identifier 365 identifies the owner (or authorized user) of the encryption key 270. The application share primary key 385 identifies the key share record 325 and may be generated many ways including using a re-encrypted version of the encryption key 270. Examples of other types of fields in clued a record type 420. Record type 420 could be a flag F which indicates what type of record the record is. For example, a value of F equal to S could indicate that the record is a share record 325. Alternatively, a value of F equal to D could indicate that the record is a data record. Each of the key share records 325 should be stored in a different bucket among the buckets (241, 242, 243, . . . 249) using LH* addressing at 540.

Encrypted application data 335 may be generated by encrypting the application data 250 with encryption key(s) 270 at 550. The encrypted application data 335 may be stored in at least one encrypted data record 345 at 560. FIG. 4A is a block diagram of an example encrypted data record 345. As shown, each encrypted data record 345 also includes many fields including but not limited to a user identifier 365, a unique key number 355 and an application data primary key 375. The unique key number 355 identifies an encryption key 270 used to encrypt the encrypted application data 355 found in the same encrypted data record 345. The user identifier 365 identifies the owner (or authorized user) of the encrypted data record 345. The application data primary key 375 identifies the encrypted data record 345. Examples of other types of fields in clued a record type 410 which may have similar properties to record type 410 described above. Each of the encrypted data records 345 should be stored in a different bucket among the buckets (241, 242, 243, . . . 249) using LH* addressing at 540.

Although it may be more efficient for the encryption key(s) 270 to be symmetric, one could envision that non-symmetric keys could also be used. Each encryption key 270 may be used to encrypt one data record, several data records or all data records belonging to application data 250. Encryption key 270 may be stored in a local cache 280. Unique key number 355 may be used to identify the encryption key 270 in the local cache 280.

One of the benefits of the disclosed embodiments is that the value of k may change after the application data 250 is stored on the remote servers (131, 132, 133, . . . 139). In other words, the database may expand an contract after the application data 250 is stored on the remote servers (131, 132, 133, . . . 139) without affecting the stored application data 250.

Application data 250 may be retrieved from the remote servers (131, 132, 133, . . . 139). An example of how to accomplish this is to retrieve encrypted data record(s) 345 from buckets (241, 242, 243, . . . 249) using LH* addressing. Encrypted application data 335 may removed from encrypted data record(s) 345. The application data 250 may be recreated by decrypting the encrypted application data 335 using the decryption key identified by the unique key number 355 in the encrypted application data records 345.

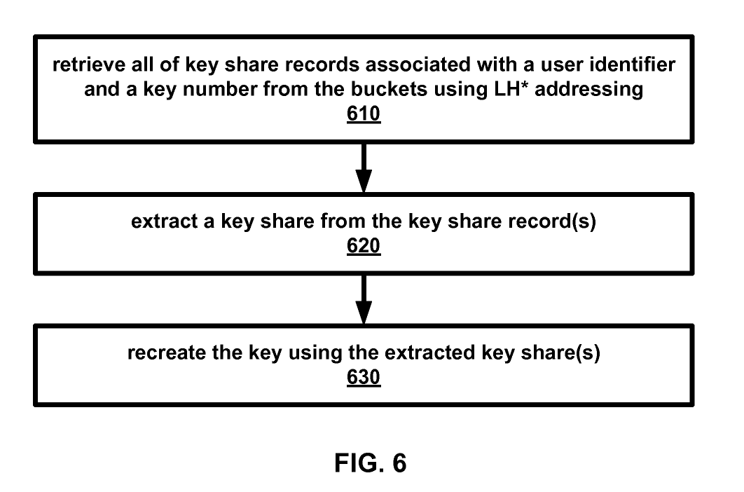

FIG. 6 is a flow diagram of an example method for recreating a key associated with a user identifier and a specific key number from key share records retrieved from multiple servers using LH* addressing. The method may be implemented as a computer readable storage medium containing a series of instructions that when executed by one or more processors, causes the one or more processors to perform a method to recreate a key. The method includes retrieving all of k+1 key share records 325 associated with a user identifier 365 and a key number 355 from among at least k+1 buckets (241, 242, 243, . . . 249) residing on at least one of k+1 remote servers (131, 132, 133, . . . 139) using LH* addressing at 610. A key share is extracted from the key share record(s) at 620. The key 270 is recreated using at least one extracted key share at 630. The key 270 may be recreated using a known or unknown secret sharing algorithm. An example of a known secret sharing algorithm includes performing an XOR on each of the key shares.

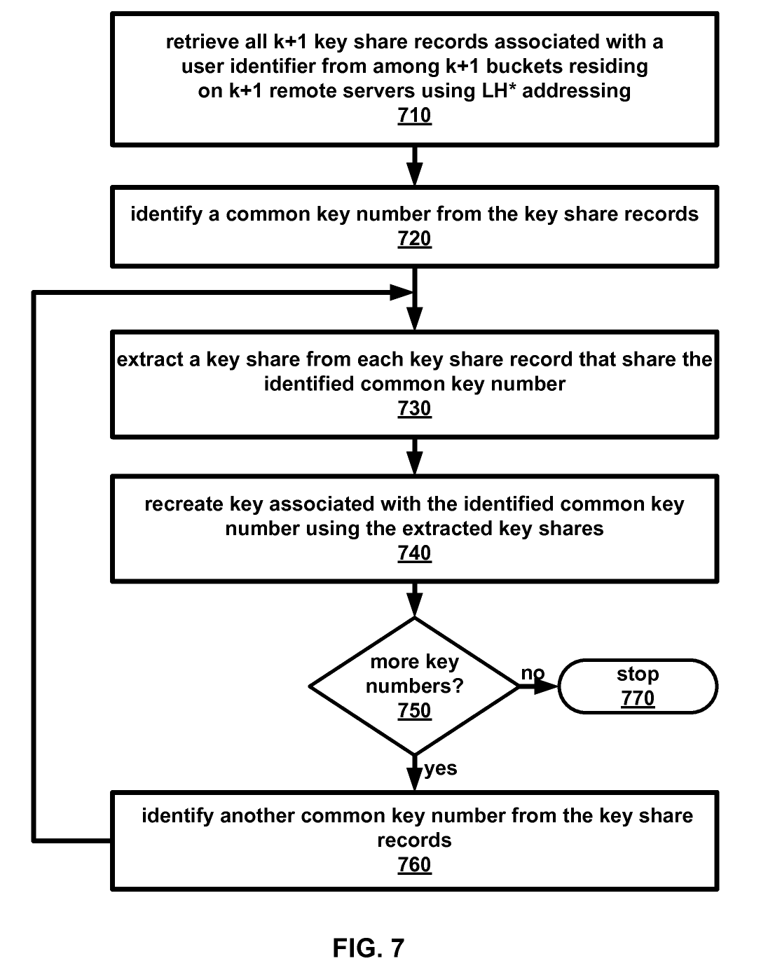

FIG. 7 is a flow diagram of an example method for recreating all keys associated with a user identifier from key share records retrieved from multiple servers using LH* addressing. The method includes retrieving all of k+1 key share records 325 associated with a user identifier 365 from among at least k+1 buckets (241, 242, 243, . . . 249) residing on at least one of at least k+1 remote servers (131, 132, 133, . . . 139) using LH* addressing at 710. At 720, key share records 325 are examined to identify a group of key share records 325 that have common key numbers 355 using the LH* scan operation. For each group of all of the key share records 325 that share a common said “key number”: a key share 315 is extracted from each of the key share records 325 at 730; the key 270 is recreated using the group of key shares 315. A decision is made at 750 to identify another group of key share records 325 that have common key numbers 355 (760) if there are more key numbers. Otherwise the method may end at 770.

It is envisioned that special requirements may make it advantageous to implement the above described embodiments in various ways. Although many of the descriptions of these embodiments are described as methods, they are not to be so limited. FIG. 3 shows a block diagram of an example implementation with specific functions implemented as modules for storing application data 250 and encryption key(s) 270 using LH*_{RE} addressing according to the previous descriptions. Similar embodiments may be created one skilled in the art for retrieving application data 250 and encryption key(s) 270 using LH*_{RE} addressing. A module is defined here as an isolatable element that performs a defined function and has a defined interface to other elements. The client machine for efficiency sake (e.g. speed, security, etc) may use special LH*_{RE} module that interacts with external devices or modules to obtain and store encryption key(s) 270, input and output application data 250, and/or input and output data streams 395 to/from remote servers (131, 132, 133, . . . 139).

As shown in FIG. 3, the LH*_{RE} module 260 includes a key share generation module 310, a key share record module 320, an application data encryption module 330, an application data record module 340, and an LH*_{RE} server interaction module 390. The key share generation module 310 is configured to generate key share(s) 315 from encryption keys 270. The key share record module 320 is configured to generate key share records 325 from at least key shares 315, key numbers 355, user identifiers 365 and share primary keys 385. The application data encryption module 330 is configured to generate encryption application data 335 from application data 250. The application data record module 340 is configured to generate encryption data records 345 from at least encryption application data 335, key numbers 355, user identifiers 365 and application data primary keys 385 keys. LH*RE server interaction module 390 is configured to communicate key share records 325 and encryption application data records 345 with remote servers (131, 132, 133, . . . 139).

The modules described in this disclosure may be implemented in hardware, software, firmware, or a combination thereof, all of which are behaviorally equivalent. For example, modules may be implemented as a software routine written in a computer language (such as C, C++, Fortran, Java, Basic, Matlab or the like) or a modeling/simulation program such as Simulink, Stateflow, GNU Octave, or LabVIEW MathScript. Additionally, it may be possible to implement modules using physical hardware that incorporates discrete or programmable analog, digital and/or quantum hardware. Examples of programmable hardware include: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. Finally, it needs to be emphasized that the above mentioned technologies are often used in combination to achieve the result of a functional module.

While various embodiments have been described above, it should be understood that they have been presented by way of example, and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above described exemplary embodiments. In particular, it should be noted that, for example purposes, the above explanation has focused on the example(s) related to information storage in record form similar to that used with databases. However, one skilled in the art will recognize that embodiments of the invention could be used for storing any type of application data (e.g. office documents, accounting data, multimedia content etc.) where a user wants scalable storage with their own encryption without needing to deal with complex key management.

In addition, it should be understood that any figures which highlight the functionality and advantages, are presented for example purposes only. The disclosed architecture is sufficiently flexible and configurable, such that it may be utilized in ways other than that shown. For example, the steps listed in any flowchart may be re-ordered or only optionally used in some embodiments.

In this specification, “a” and “an” and similar phrases are to be interpreted as “at least one” and “one or more.”

The disclosure of this patent document incorporates material which is subject to copyright protection. The copyright owner has no objection to the facsimile reproduction by anyone of the patent document or the patent disclosure, as it appears in the Patent and Trademark Office patent file or records, for the limited purposes required by law, but otherwise reserves all copyright rights whatsoever.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope in any way.

Finally, it is the applicant's intent that only claims that include the express language “means for” or “step for” be interpreted under 35 U.S.C. 112, paragraph 6. Claims that do not expressly include the phrase “means for” or “step for” are not to be interpreted under 35 U.S.C. 112, paragraph 6.

What is claimed is:

1. A computer readable storage medium containing a series of instructions that when executed by one or more processors causes the one or more processors to perform a method to store application data on at least one remote server, the method comprising:
a) creating at least k+1 buckets;
b) generating at least k+1 key share for each of at least one encryption key;
c) storing each of said at least k+1 key shares in one of said at least one key share records, each of said key share records further including a user identifier and a primary key;
d) storing on said at least one remote server, each of said at least one key share record into a different bucket among said at least one k+1 buckets using LH* addressing;
e) generating encrypted application data by encrypting said application data with said at least one encryption key;
f) storing said encrypted application data in at least one encrypted data record; and
g) storing on said at least one remote server, each of said at least one encrypted data record in at least one of said at least one k+1 buckets using said LH* addressing.

2. The medium according to claim 1, wherein said at least k+1 key share is generated using noise.

3. The medium according to claim 1, wherein said at least k+1 key share is generated using a re-encrypted version of said at least one encryption key.

4. The medium according to claim 1, wherein said at least one encryption key includes at least one symmetric key.

5. The medium according to claim 1, wherein at least two of said at least one remote server are geographically diverse.

6. The medium according to claim 1, wherein at least two of said at least one remote server are under control of different organizations.

7. The medium according to claim 1, wherein a different one of said at least one encryption key is uses to encrypt said encrypted application data stored in each of said at least one encrypted data record.

8. The medium according to claim 1, wherein one of said at least one encryption key is uses to encrypt said encrypted application data stored in each of said at least one encrypted data record.

9. The medium according to claim 1, further including caching locally at least one of said at least k+1 key share.

10. The medium according to claim 1, further including caching locally at least one of said at least one encryption key.

11. The medium according to claim 1, wherein the value of k is changed after said application data is stored on said at least one remote server.

12. A computer readable storage medium containing a series of instructions that when executed by one or more processors causes the one or more processors to perform a method to retrieve application data from at least one remote server, the method comprising:
a) retrieving an encrypted data record from at least one of at least one k+1 buckets residing on at least one of said at least one remote server, using LH* addressing and a primary key;
b) removing encrypted application data from said encrypted data record; and
c) recreating said application data by decrypting said encrypted application data using at least one decryption key.

13. The medium according to claim 12, wherein said at least one decryption key includes at least one symmetric key.

14. The medium according to claim 12, wherein at least two of said at least one remote server are geographically diverse.

15. A computer readable storage medium containing a series of instructions that when executed by one or more processors causes the one or more processors to perform a method to recreate a key, the method comprising:
a) retrieving all of at least one key share record associated with a user identifier and a key number from among at least k+1 buckets residing on at least one of at least one remote server using LH* addressing;
b) extracting at least one key share from said at least one key share record;
c) recreating said key using said at least one extracted key share.

16. The medium according to claim 15, wherein said key is a symmetric key.

17. The medium according to claim 15, wherein said key is a decryption key.

18. The medium according to claim 15, wherein at least two of said at least one remote server are under control of different organizations.

19. The medium according to claim 15, wherein said key is recreated using a secret sharing algorithm.

20. The medium according to claim 19, wherein said secret sharing algorithm includes performing an XOR on each of said at least one key share.
